(19) United States
(12) Patent Application Publication
(10) Pub. No.: US 2026/0225852 A1
(43) Pub. Date: Aug. 6, 2026

(54) ELEVATOR SUSPENSION MEMBER MONITORING SYSTEM

(71) Applicant: OTIS ELEVATOR COMPANY, Farmington, CT (US)

(72) Inventors: Yingxin Gao, Farmington, CT (US); ZhenXing Peng, Farmington, CT (US); Kyle B. Martin, Avon, CT (US); Bardia Guilani, Woodstock Valley, CT (US)

(21) Appl. No.: 19/045,671

(22) Filed: Feb. 5, 2025

(51) Int. Cl. B66B 7/12; B66B 1/34

(52) U.S. Cl. CPC B66B 7/1215; B66B 1/3446

(57) ABSTRACT

A system includes at least one suspension member that facilitates movement of an elevator car within a hoistway and at least one connector that couples the at least one suspension member to a monitoring device. A chip is associated with at least one of the suspension member and the connector and includes identifier information associated with the at least one suspension member. The chip is configured to track and communicate a number of cycles of the at least one suspension member to the monitoring device.

### BACKGROUND

Elevator systems are in widespread use for carrying passengers between various levels in buildings, for example. Elevator systems utilize one or more tension members operably connected to an elevator car and a counterweight in combination with, for example, a machine and traction sheave, to suspend and drive the elevator car along a hoistway. In some systems, the tension member is a belt having one or more tension elements retained in a jacket. When operating an elevator system, it is imperative that authentic belts are installed and monitored over time, such that the belts will meet performance standards and requirements for the elevator system.

### SUMMARY

An illustrative example system includes: at least one suspension member that facilitates movement of an elevator car within a hoistway; at least one connector that couples the at least one suspension member to a monitoring device; and a chip that is associated with at least one of the suspension member and the connector, wherein the chip includes identifier information associated with the at least one suspension member and is configured to track and communicate a number of cycles of the at least one suspension member to the monitoring device.

In addition to one or more of the features described herein, or as an alternative, the chip comprises a re-writable chip.

In addition to one or more of the features described herein, or as an alternative, the at least one suspension member comprises a belt.

In addition to one or more of the features described herein, or as an alternative, the chip is tamper-proof.

In addition to one or more of the features described herein, or as an alternative, the chip is configured to track usage time of the at least one suspension member and communicate the usage time to the monitoring device.

In addition to one or more of the features described herein, or as an alternative, the monitoring device comprises an elevator controller that communicates a notification signal if one or more of the following occurs: the identifier information in the chip of the at least one suspension member does not match suspension identifier information in the elevator controller for an authentic suspension member;
the usage time exceeds a predetermined time limit; the number of cycles exceeds a maximum cycle limit.

In addition to one or more of the features described herein, or as an alternative, the chip is embedded within the connector or the suspension member.

In addition to one or more of the features described herein, or as an alternative, the chip is placed on an outer surface of the connector or the suspension member and covered with a protective material.

An illustrative example system includes: an elevator car; at least one belt that facilitates movement of the elevator car within a hoistway; at least one connector that couples the at least one belt to a monitoring device; and a chip that is associated with at least one of the belt and the connector, wherein the chip includes identifier information associated with the at least one belt and is configured to track and communicate a number of cycles of the at least one belt to the monitoring device.

In addition to one or more of the features described herein, or as an alternative, the chip comprises a re-writable chip.

In addition to one or more of the features described herein, or as an alternative, the belt comprises a coated steel belt.

In addition to one or more of the features described herein, or as an alternative, the chip is configured to track usage time of the at least one belt and communicate the usage time to the monitoring device, and wherein the monitoring device comprises an elevator controller that communicates a notification signal if one or more of the following occurs:
the identifier information in the chip of the at least one belt does not match suspension identifier information in the elevator controller for an authentic belt;
the usage time exceeds a predetermined time limit;
the number of cycles exceeds a maximum cycle limit.

In addition to one or more of the features described herein, or as an alternative, the chip is embedded within the connector or the belt.

An illustrative example method includes: connecting at least one suspension member to a monitoring device with at least one connector; associating a chip with at least one of the suspension member and the connector, wherein the chip includes identifier information associated with the at least one suspension member; and tracking and communicating a number of cycles of the at least one suspension member to the monitoring device via the chip.

In addition to one or more of the features described herein, or as an alternative, the chip comprises a re-writable chip.

In addition to one or more of the features described herein, or as an alternative, the at least one suspension member comprises a belt.

In addition to one or more of the features described herein, or as an alternative, the chip is tamper-proof.

In addition to one or more of the features described herein, or as an alternative, the method includes tracking usage time of the at least one suspension member and communicating the usage time to the monitoring device via the chip.

In addition to one or more of the features described herein, or as an alternative, the monitoring device comprises an elevator controller, and the method includes communicating a notification signal from the elevator controller if one or more of the following occurs: the identifier information in the chip of the at least one suspension member does not match suspension identifier information in the elevator controller for an authentic suspension member; the usage time exceeds a predetermined time limit; the number of cycles exceeds a maximum cycle limit.

In addition to one or more of the features described herein, or as an alternative, the method includes embedding the chip within the connector or the suspension member.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 schematically illustrates a portion of an example suspension member.

FIG. 3 schematically illustrates a chip that is embedded within a suspension member.

FIG. 4 schematically illustrates a chip that is protected on an outer surface of the suspension member

FIG. 5 schematically illustrates a chip that is associated with a connector.

FIG. 6 is a flowchart diagram of an example implementation of a method of communicating with the chip.

### DETAILED DESCRIPTION

Health monitoring of elevator suspension members, such as coated steel belts (CSB) for example, requires a connector interface between the suspension members and the health monitoring device, e.g., an electrical/electronic device. Embodiments of this disclosure provide a chip, which is associated with at least one of the suspension member and the connector, and that includes identifier information associated with the suspension member for authentication purposes. The chip is configured to track and communicate a number of cycles of the suspension member to the monitoring device.

FIG. 1 schematically illustrates selected portions of an elevator system 10. An elevator car 12 is supported by a roping arrangement or suspension assembly 14 that includes a plurality of suspension members 16. The elevator car 12 is coupled to a counterweight 22 by the suspension members 16. The suspension members 16 move around one or more sheaves 18 as the elevator car 12 moves between landings or levels along a hoistway 50.

At least one of the sheaves may be a traction sheave 24 that is driven by a machine 26 to move the suspension members 16 around the traction sheave 24. Some of the other sheaves 18 may include diverter, deflector or idler sheaves that help guide the suspension members 16 around various components of the elevator system 10. The example of FIG. 1 shows a 1:1 roping arrangement in which the one or more suspension members 16 terminate at the car 12 and counterweight 22; however, other roping arrangements may also be used.

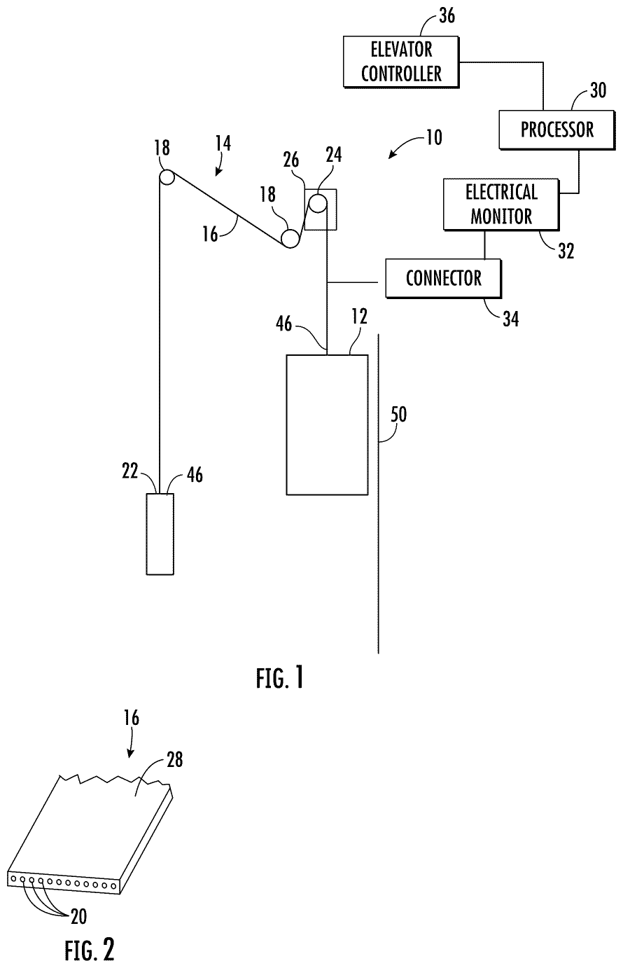

In some implementations, the suspension members 16 are flat belts or other types of ropes that have tension members 20 encased in a jacket 28 as shown in FIG. 2, for example.

In some implementations, a suspension member monitoring device, e.g., a health monitoring device, includes at least one processor 30 that is configured to determine a condition of each of the suspension members 16. The processor 30 in the illustrated example includes a computing device and associated memory. The processor 30 is programmed or otherwise configured to use different types of information indicative of the respective conditions of the suspension members 16 and a combination of criteria to determine when it is desirable or necessary to remove or retire any one of the suspension members 16 from service.

An electric-based monitoring device 32 uses an electrical inspection technique and generates or provides a corresponding indication regarding a condition of each suspension member 16. The processor 30 receives the indication from the electric-based monitoring device 32 and communicates with an elevator controller 36.

In some implementations, the electric-based monitoring device 32 comprises a health monitoring device.

In some example embodiments, the electric-based monitoring device 32 is configured to monitor a number of cycles and/or usage time for the suspension member 16.

FIG. 2 schematically illustrates a portion of an example suspension member 16. In the illustrated embodiment, the suspension member 16 is a flat belt including the plurality of cords or tension members 20 encased in the jacket 28, which is made of a compressible material, such as polyurethane. In many embodiments, the tension members 20 comprise steel cords. Other embodiments include tension members that are made of different materials. Additional embodiments may include belts with lengthwise surface features on one or both sides.

In some implementations, a connector 34 is used to connect the electric-based monitor 32 to an associated suspension member 16 as shown in FIG. 1.

In one example implementation, a chip 38 is associated with at least one of the suspension member 16 and the connector 34.

In some implementations, the chip 38 includes identifier information associated with the suspension member 16.

In some implementations, the information that will be stored on the chip 38 includes one or more of the following suspension member characteristics: manufacturer; minimum brake load (MBL); production date; number of maximum cycles; maximum usage time; etc.

In some implementations, the chip 38 is configured to track and communicate a number of cycles of the suspension member 16 to the monitoring device 32.

In one example, the electric-based monitoring device 32 wirelessly communicates suspension member information to the processor 30 and controller 36.

In some implementations, the chip 38 is installed in a tamper-proof configuration or comprises a one-time-use chip. These types of embodiments are designed to ensure that once chip is installed, any attempt to remove the chips will damage or destroy the chip, preventing re-use.

In one example, the chip comprises a re-writable chip. A re-writable chip is a type of microchip that allows data to be written, erased, and rewritten multiple times.

For example, the chip 38 can be continuously updated with a cycle count for an associated suspension member 16. In some implementations, the cycle count of an elevator suspension member refers to a number of complete operational cycles the suspension member undergoes during its use. In one example, a cycle typically represents one full movement of the elevator suspension member through its intended range of motion, which often involves the suspension member running up and down in conjunction with the elevator's operation.

Tracking cycle counts is beneficial from a maintenance aspect. Manufacturers may often define a recommended cycle limit or lifespan for an elevator suspension member. For example, regular inspections and maintenance are scheduled based on cycle counts. This is because elevator suspension members may experience fatigue and degradation with use over time. Tracking cycles may help anticipate when the suspension member might need replacement or servicing.

In one example, the monitoring device 32 uses appropriate software to communicate with the chip 38 such that cycle counts can be automatically tracked and technicians can be alerted when maintenance is due.

In one example, the chip 38 is configured to track usage time of the suspension member 16 and communicate the usage time to the monitoring device 32.

In some implementations, the monitoring device 32 uses the elevator controller 36 and/or processor 30 to communicate a notification signal if one or more of the following occurs: the identifier information in the chip 38 associated with a suspension member 16 does not match suspension identifier information in the elevator controller 36 for an authentic suspension member 16; the usage time exceeds a predetermined time limit; the number of cycles exceeds a maximum cycle limit.

In some implementations, the chip 38 is embedded within the connector 34 or the suspension member 16.

In one example shown in FIG. 3, the chip 38 is embedded within the suspension member 16.

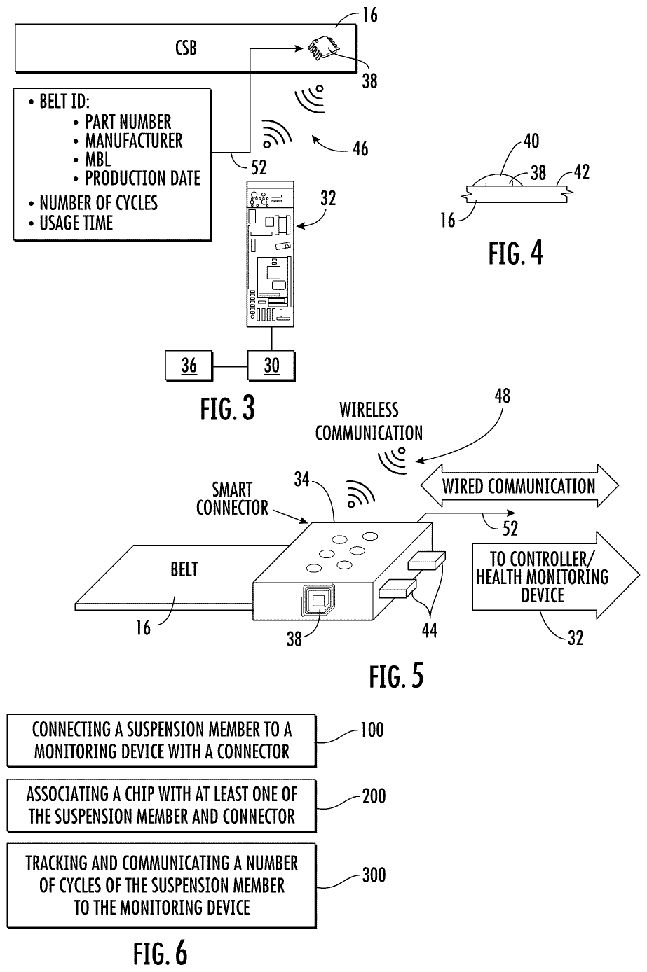

In another example shown in FIG. 4, the chip 38 is placed on an outer surface 42 of the suspension member 16 and covered with a protective material 40.

In one example shown in FIG. 5, the chip 38 is embedded within the connector 34.

In another example, the chip 38 is placed on an outer surface of the connector 34 and covered with a protective material 40 similar to that as shown in FIG. 4.

The connector 34 includes electrical connections or contacts 44 that electrically connect the connector 34 to the monitoring device 32.

The present disclosure also discloses a method (see FIG. 6) that includes the steps of: connecting at least one suspension member to a monitoring device with at least one connector (see 100); associating a chip with at least one of the suspension member and the connector, wherein the chip includes identifier information associated with the at least one suspension member (see 200); and tracking and communicating a number of cycles of the at least one suspension member to the monitoring device via the chip (see 300).

The method may include any of the following steps either alone or in any combination thereof.

In one example, the method may include the chip being a re-writable chip.

In one example, the method may include the at least one suspension member being a belt.

In one example, the method may include the chip being tamper-proof.

In one example, the method may include tracking usage time of the at least one suspension member and communicating the usage time to the monitoring device via the chip.

In one example, the method may include the monitoring device being an elevator controller, and including communicating a notification signal from the elevator controller if one or more of the following occurs: the identifier information in the chip of the at least one suspension member does not match suspension identifier information in the elevator controller for an authentic suspension member; the usage time exceeds a predetermined time limit; the number of cycles exceeds a maximum cycle limit.

In one example, the method may include embedding the chip within the connector or the suspension member.

In some implementations, the disclosure provides a method to store identification information in the suspension member itself. In one example, the chip 38 may be attached to an end of the suspension member 16 after the suspension member is cut in the factory. The chip 38 may be either embedded in the elastomer jacket material of a belt, for example, or may be placed on the surface and then covered by a protective material such that the chip 38 will be non-removable. As shown in FIG. 3, for example, the information that may be stored on the chip 38 includes belt identification information, e.g., manufacturer, MBL, production date, the number of cycles, the usage time etc.

In some implementations, during installation of a new suspension member 16, the number of cycles will be set to be 0. When the suspension member 16 is installed, the 36 controller will communicate wirelessly 46 with the chip 38 to check the suspension member identification information to verify that the identification information is consistent with the identification information that is stored in the controller 36 to allow the operation of the unit. The controller 36 may then continue communication with the chip 38 to track the number of cycles stored in the chip to start the cycle counting for the associated suspension member 16.

In some implementations, the number of cycles in the chip 38 will be updated in real time and cannot be reset any time.

In some implementations, if there is no communication between the controller 36 and the chip 38, or if there is an inconsistent reading/comparison of a number cycles from between the chip 38 and the controller 36, the controller 36 may cease operation of the elevator.

In one example, the chip 38 may also be used to count the cycles directly and backup the data in the controller 36.

In one example, the chip 38 is associated with a connector 34 that is referred to as a “smart” connector as shown in FIG. 5. This configuration can also provide belt authentication and recording of cycle counts.

In one example, the smart connector incorporates circuitry such as RFID or similar devices to enable communication 48 with the controller 36 during installation and commissioning of the elevator system.

In some examples, the communication between the controller/health monitoring device can be wireless as with an RFID chip or may be via a simpler wired communication as shown at 52 in FIGS. 3 and 5.

In one example, the controller 36 may not allow system operation if the chip 38 is not detected or if the proper identification information for the suspension member is not found/read.

As such, the subject disclosure uses the chip to ensure that no counterfeit suspension members can be used in the elevator system, while also providing a robust mechanism that can track a number of operational cycles and/or usage time.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A system comprising:
at least one suspension member that facilitates movement of an elevator car within a hoistway;
at least one connector that couples the at least one suspension member to a monitoring device; and
a chip that is associated with at least one of the suspension member and the connector, wherein the chip includes identifier information associated with the at least one suspension member and is configured to track and communicate a number of cycles of the at least one suspension member to the monitoring device.

2. The system of claim 1, wherein the chip comprises a re-writable chip.

3. The system of claim 1, wherein the at least one suspension member comprises a belt.

4. The system of claim 1, wherein the chip is tamper-proof.

5. The system of claim 1, wherein the chip is configured to track usage time of the at least one suspension member and communicate the usage time to the monitoring device.

6. The system of claim 5, wherein the monitoring device comprises an elevator controller that communicates a notification signal if one or more of the following occurs:
the identifier information in the chip of the at least one suspension member does not match suspension identifier information in the elevator controller for an authentic suspension member;
the usage time exceeds a predetermined time limit;
the number of cycles exceeds a maximum cycle limit.

7. The system of claim 1, wherein the chip is embedded within the connector or the suspension member.

8. The system of claim 1, wherein the chip is placed on an outer surface of the connector or the suspension member and covered with a protective material.

9. A system comprising:
an elevator car;
at least one belt that facilitates movement of the elevator car within a hoistway;
at least one connector that couples the at least one belt to a monitoring device; and
a chip that is associated with at least one of the belt and the connector, wherein the chip includes identifier information associated with the at least one belt and is configured to track and communicate a number of cycles of the at least one belt to the monitoring device.

10. The system of claim 9, wherein the chip comprises a re-writable chip.

11. The system of claim 9, wherein the belt comprises a coated steel belt.

12. The system of claim 9, wherein the chip is configured to track usage time of the at least one belt and communicate the usage time to the monitoring device, and wherein the monitoring device comprises an elevator controller that communicates a notification signal if one or more of the following occurs:
the identifier information in the chip of the at least one belt does not match suspension identifier information in the elevator controller for an authentic belt;
the usage time exceeds a predetermined time limit;
the number of cycles exceeds a maximum cycle limit.

13. The system of claim 9, wherein the chip is embedded within the connector or the belt.

14. A method comprising:
connecting at least one suspension member to a monitoring device with at least one connector;
associating a chip with at least one of the suspension member and the connector, wherein the chip includes identifier information associated with the at least one suspension member; and
tracking and communicating a number of cycles of the at least one suspension member to the monitoring device via the chip.

15. The method of claim 14, wherein the chip comprises a re-writable chip.

16. The method of claim 15, wherein the at least one suspension member comprises a belt.

17. The method of claim 14, wherein the chip is tamper-proof.

18. The method of claim 14, including tracking usage time of the at least one suspension member and communicating the usage time to the monitoring device via the chip.

19. The method of claim 18, wherein the monitoring device comprises an elevator controller, and including communicating a notification signal from the elevator controller if one or more of the following occurs:
the identifier information in the chip of the at least one suspension member does not match suspension identifier information in the elevator controller for an authentic suspension member;
the usage time exceeds a predetermined time limit;
the number of cycles exceeds a maximum cycle limit.

20. The method of claim 14, including embedding the chip within the connector or the suspension member.
